(19) United States
(12) Patent Application Publication
(10) Pub. No.: US 2009/0135695 A1
(43) Pub. Date: May 28, 2009

(54) Method of detecting an abnormal disc

(75) Inventors: Chia-Hsing Hsu, Taoyuan (TW); Yi-Long Hsiao, Taoyuan (TW)

Correspondence Address: BACON & THOMAS, PLLC, 625 SLATERS LANE, FOURTH FLOOR, ALEXANDRIA, VA, 22314-1176, US

(73) Assignee: QUANTA STORAGE INC., Taoyuan (TW)

(21) Appl. No.: 12/289,113

(22) Filed: Oct. 21, 2008

(30) Foreign Application Priority Data
Nov. 23, 2007 (TW) 96144700

(51) Int. Cl. G11B 20/18

(52) U.S. Cl. 369/53.15; G9B/20.046

(57) ABSTRACT

A method of detecting an abnormal disc is provided. Firstly, an objective lens is moved along a one-way path for enabling the light beam of the objective lens to pass through the data layer of a disc. Next, the path having RF signal is detected and recorded. Then, whether the terminal of the one-way path is reached is determined: if the terminal is not reached, the method continues to move the objective lens; if the terminal is reached, the method calculates the length of vibration path on which RF signal is detected. After that, whether the length of vibration path is larger than a path threshold is determined: if the length of vibration path is not larger than a path threshold, the disc is a normal disc; if the length of vibration path is larger than the path threshold, the disc is an abnormal disc.

This application claims the benefit of Taiwan application Serial No. 96144700, filed Nov. 23, 2007, the subject matter of which is incorporated herein by reference.

### BACKGROUND OF THE INVENTION

1. Field of the Invention

The invention relates in general to a disc detecting method of a disc drive, and more particularly to a method of detecting an abnormal disc which vibrates when a disc drive rotates.

2. Description of the Related Art

The disc used in disc drive is made of plastic material by way of molding. During the manufacturing process, transportation or storage, if the properties of the material change or the disc is not uniformly heated, properly cooled down, uniformly coated or pressed, the weight of the disc may be out of balance and the disc may even be uneven or curled. As a result, when the disc is rotated by a disc drive, the disc will vibrate up and down and the disc drive will be severely affected in accessing data from or writing data to the disc.

As indicated in FIG. 1, a focusing process of a conventional disc W drive is shown. When the disc drive focuses, the electromagnetism generated by voltage impulse moves the objective lens 2 of the pick-up head 1 up and down and controls the objective lens 2 to project a light beam on the disc W. Then, the light beam is reflected back to the pick-up head 1 by the data layer L of the disc W, passes through the column lens 3 of the pick-up head 1 and is projected on the photo-electric converter 5 of the light spot 4. The photo-electric converter 5 comprises four light reception portions namely A, B, C and D for receiving different parts of the light spot 4 and further converting the light beam into an electrical signal according to the intensity of the light beam. Then, the electrical signal is amplified as an RF signal by a radio frequency (RF) amplifier 6.

As the projection of the column lens 3 is asymmetric, the shape of the light spot 4 changes asymmetrically as the objective lens 2 moves away from or towards the data layer L, and when the light spot 4 becomes symmetric circular, the objective lens 2 exactly focuses on the data layer L. Thus, an S-shaped focus error signal FE (such as the U curve in the diagram) is generated when the objective lens 2 is moved away from or towards the data layer L by the difference of the intensity of the light beam having four light reception portions such as (A+C)−(B+D). When the objective lens 2 focuses on the data layer L, the light spot 4 is symmetric circular and forms a zerocrossing point whose focus error signal FE is 0, and the focus servo uses the zerocrossing point for focus fixing. Besides, the RF signal generated by the light integral of the light reception portion A, B, C, D, that is, (A+B+C+D), is used as a data signal such as the V curve in the diagram. When the focus is fixed on the data layer L, the data signal remains at the best level and assures that the disc drive can read/write data correctly.

The higher rate of rotation the disc drive rotates the disc at, the faster the disc drive can read/write data of the disc, and the shorter the required time is. However, when an abnormal disc is rotated at a high rotation rate, the disc vibrates up and down even worse and more frequently, making the fixing of focus more difficult. The rotation rate must slow down for the focus to be fixed. Some conventional disc drives detect whether a disc is an abnormal disc according to the change in the position of the objective lens caused by the voltage impulse of the objective lens relative to the zerocrossing points of consecutive focus error signals by way of moving the objective lens upwardly and downwardly for several times. The conventional detecting method needs to repeatedly drive the objective lens to move upwardly and downwardly and involves a complicated calculation of detection, not only requiring longer detection time but also having other problems. For example, when the disc vibrates upwardly and downwardly, the position of the objective lens relative to the zerocrossing point of the focus error signal is hard to determine precisely due to system delay and misjudgment may thus occur. Thus, the above method of detecting the abnormal disc still has many problems remain unresolved.

### SUMMARY OF THE INVENTION

The invention is directed to a method of detecting an abnormal disc. An abnormal disc is detected if the length of vibration path of RF signal distribution obtained by enabling a light beam to pass the data layer of a disc along a one-way path is larger than the path threshold of an RF signal distribution of a normal disc.

According to a first aspect of the present invention, a method of detecting an abnormal disc is provided. The path length of the RF signal distribution obtained by enabling a light beam to pass the data layer is graded and used as a reference index for the response in servo control of disc drive.

According to a second aspect of the present invention, a method of detecting an abnormal disc is provided. When the light beam passes through the data layer, whether the disc is an abnormal disc is determined according to the determination of whether the predetermined path has an RF signal after the RF signal is obtained. Thus, the abnormal disc is quickly determined and the detection efficiency is improved accordingly.

To achieve the above object of the invention, the method of detecting the abnormal disc of the invention comprises the following steps. Firstly, an objective lens is moved along a one-way path for enabling the light beam of the objective lens to pass through the data layer of a disc. Next, the path having the RF signal is detected and recorded. Then, whether the terminal of the one-way path is reached is determined: if the terminal of the one-way path is not reached, the method returns to the step of moving the objective lens, and if the terminal of the one-way path is reached, the method calculates the length of vibration path on which an RF signal is detected. After that, whether the length of vibration path is larger than a path threshold is determined: if the length of vibration path is not larger than a path threshold, the disc is determined as a normal disc, and if the length of vibration path is larger than the path threshold, the disc is determined as an abnormal disc.

According to the method of detecting the abnormal disc of the invention, whether the length of vibration path is larger than a first level path threshold can be determined after the disc is determined as an abnormal disc. If the length of vibration path is not larger than a first level path threshold, the disc is determined as a first level abnormal disc. If the length of vibration path is larger than the first level path threshold, the disc is determined as a second level abnormal disc. Thus, the vibration of abnormal disc is further graded. Lastly, the result of the determination is provided for the reference of servo control of disc drive to step down the rotation rate of the disc.

Another method of detecting an abnormal disc is disclosed in another embodiment of the invention. Firstly, the objective lens is moved for enabling a light beam to pass through the data layer of a disc. Next, whether an RF signal is detected is determined. If no RF signal is detected, the method continues to move the objective lens. If the RF signal is detected, the position of the detected RF signal is used as a starting point and the objective lens continues to move along a predetermined path larger than a path vibration threshold acceptable to a normal disc. Next, the method continues to detect the RF signal. If the RF signal is detected, the disc is determined as an abnormal disc. If no RF signal is detected, whether the predetermined path is reached is determined. If the predetermined path is not reached, the method continues to move the objective lens. If the predetermined path is reached, the disc is determined as a normal disc.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) shows a focusing process of a conventional disc drive;

FIG. 2 shows a process of moving the light beam of an objective lens to pass through the data layer of a disc and generate a signal according to a first embodiment of the invention;

FIG. 3 shows a flowchart of a method of detecting an abnormal disc according to a first embodiment of the invention;

FIG. 4 shows a flowchart of a method of detecting an abnormal disc according to a second embodiment of the invention;

FIG. 5 shows a process of moving the objective lens along a predetermined path to generate a signal according to a third embodiment of the invention; and

FIG. 6 shows a flowchart of a method of detecting an abnormal disc according to a third embodiment of the invention.

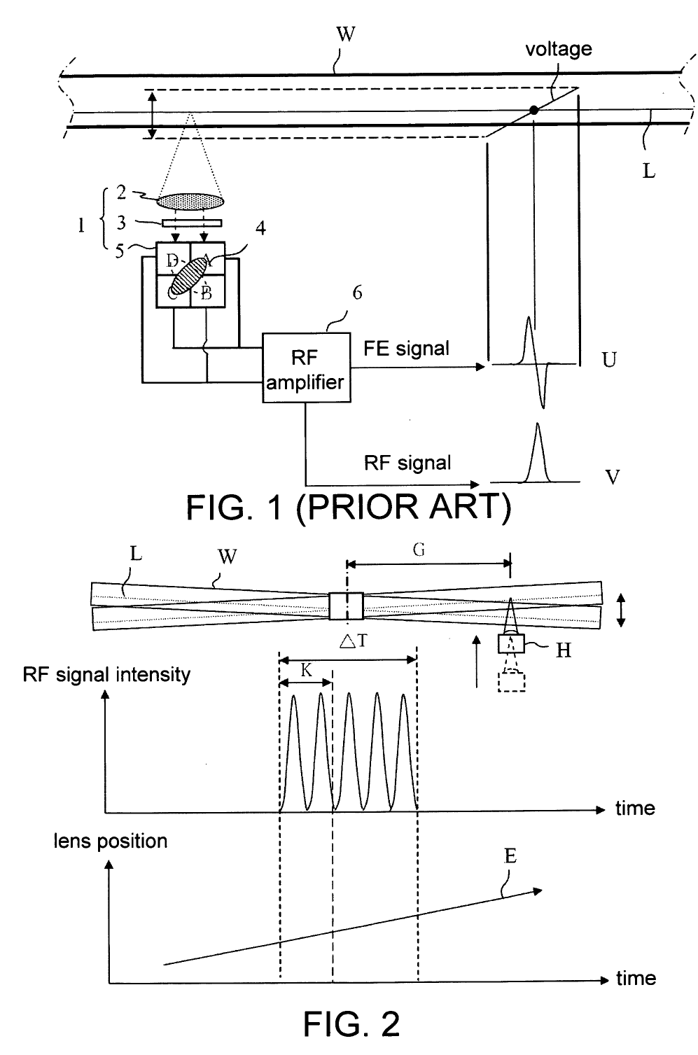

### DETAILED DESCRIPTION OF THE INVENTION

The technologies and methods used to achieve the above objects of the invention are exemplified in the following preferred embodiments with accompanying drawings.

Referring to FIG. 2, a process of moving the light beam of an objective lens H to pass through the data layer L of a disc W and generate a signal according to a first embodiment of the invention is shown. Normally, the disc W is rotated by a disc drive, and the disc drive can move the objective lens H upwardly or downwardly for enabling the light beam to pass through the data layer L of the disc W to detect whether the disc is abnormal. In the present embodiment of the invention, the objective lens H is moved upwardly to pass through the data layer L of the disc. In the predetermined radius G of the disc W, when the disc drive moves the objective lens H upwardly at a predetermined speed (referring to the line E in the diagram), the objective lens H is moved to approach the disc W. Before the light beam touches the data layer L, the light beam is scattered and is unable to generate an effective RF signal, and the intensity of the RF signal is almost zero. Once the light beam approaches the data layer L, the generated RF signal swells fast along with the increase in the flux of the reflected light, and the intensity of the RF signal reaches a maximum when the light beam is focused on the data layer L. Once the light beam passes through the data layer L, the intensity of the RF signal fades. As the focal point of the light beam moves away from the data layer L, the intensity of the RF signal drops to zero quickly.

Suppose the disc W does not generate vertical vibration and the objective lens H is pushed upwardly, the light beam projected from the objective lens H only passes through the data layer L once and can only obtain one peak of the RF signal. However, due to the structure of the disc drive or the disc W itself, the disc generates different levels of vertical vibration, and the farther away from the center of the disc W, the higher the rotation rate and the worse the vibration. Thus, during the vibration period of the data layer L, the light beam projected by the objective lens H passing through the data layer L will repeatedly be passed through by the data layer L which vibrates vertically and generate many intensive RF signals during the vibration path ΔT of the data layer L. When the vibration of the data layer L is crossed over, the RF signal will drop to zero and remains the same until the pushing-up process of the objective lens H finishes. Thus, the vibration path ΔT of the RF signal detected during the pushing-up process of the objective lens H is determined according to the vibration of the data layer L of the disc W.

Despite disc more or less vibrates when the disc W rotates, the vibration of a normal disc W is limited and is within the range of focus fixing. In the method of detecting the abnormal disc of the invention, the vibration range acceptable to a normal disc W is set as path threshold K. Before fixing the focus, the disc W rotates at a normal rotation rate, and in the predetermined radius G of the disc W, the objective lens H is moved along a one-way path for enabling a light beam to pass through the data layer L. If the length of vibration path ΔT on which the RF signal is detected is smaller than the path threshold K (this implies that the vibration of the disc W is within an acceptable range of fixing the focus), the disc drive can fix the focus under high rotation rate and quickly complete the access of data. Otherwise, if the length of vibration path ΔT is larger than the path threshold K (this implies that the vibration of the disc W is too large for fixing the focus), the disc is an abnormal disc. Such result is provided for the reference of servo control of disc drive to step down the rotation rate of the disc to avoid the waste in the servo control of fixing the focus under high rotation rate.

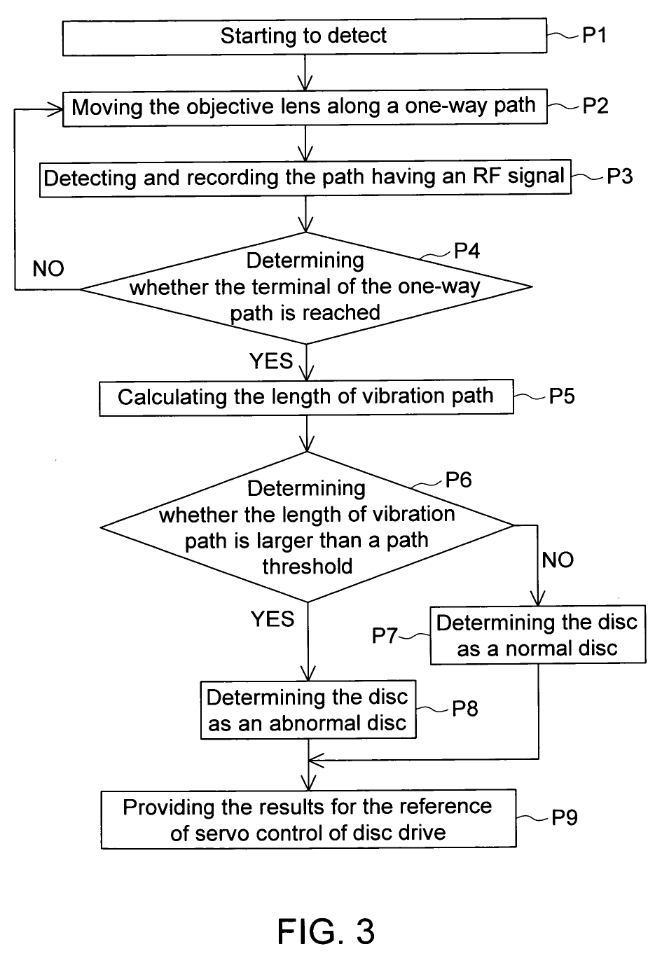

Referring to FIG. 3, a flowchart of a method of detecting an abnormal disc according to a first embodiment of the invention is shown. The steps of determining whether a disc is an abnormal disc by moving an objective lens along a one-way path are disclosed below. Firstly, the method begins at step P1, the disc drive starts to detect whether a disc is an abnormal disc. Next, the method proceeds to step P2, in the radius G of the disc W, the objective lens is moved upward or downward along a one-way path H for enabling a light beam to pass through a data layer L. Then, the method proceeds to step P3, during the path of passing through the data layer L, the path having an RF signal is detected and recorded. After that, the method proceeds to step P4, whether the terminal of the one-way path is reached is determined. If the terminal of the one-way path is not reached, the method returns to step P2 and continues moving the objective lens H, and if the terminal of the one-way path is reached, the method proceeds to step P5, the path length of the vibration path ΔT on which the RF signal is detected is calculated. Afterwards, the method proceeds to step P6, whether the length of vibration path ΔT is larger than a path threshold K is determined. If the length of vibration path ΔT is not larger than a path threshold K, the disc of step P7 is determined as a normal disc, and if the length of vibration path ΔT is larger than a path threshold K, the disc of step P8 is determined as an abnormal disc. Lastly, the method proceeds to step P9, the results of the determination made in step P7 and step P8 are provided for the reference of servo control of disc drive.

The method of detecting the abnormal disc of the first embodiment of the invention quickly determines whether a disc is an abnormal disc according to whether the length of vibration path of the RF signal obtained when the objective lens is moved along a one-way path for enabling the light beam to pass through the data layer is larger than a threshold. Thus, the method of the invention improves the conventional detecting method which employs the change in the zerocrossing point between two paths to detect whether a disc is abnormal when the disc vibrates severely and the focus is hard to be fixed.

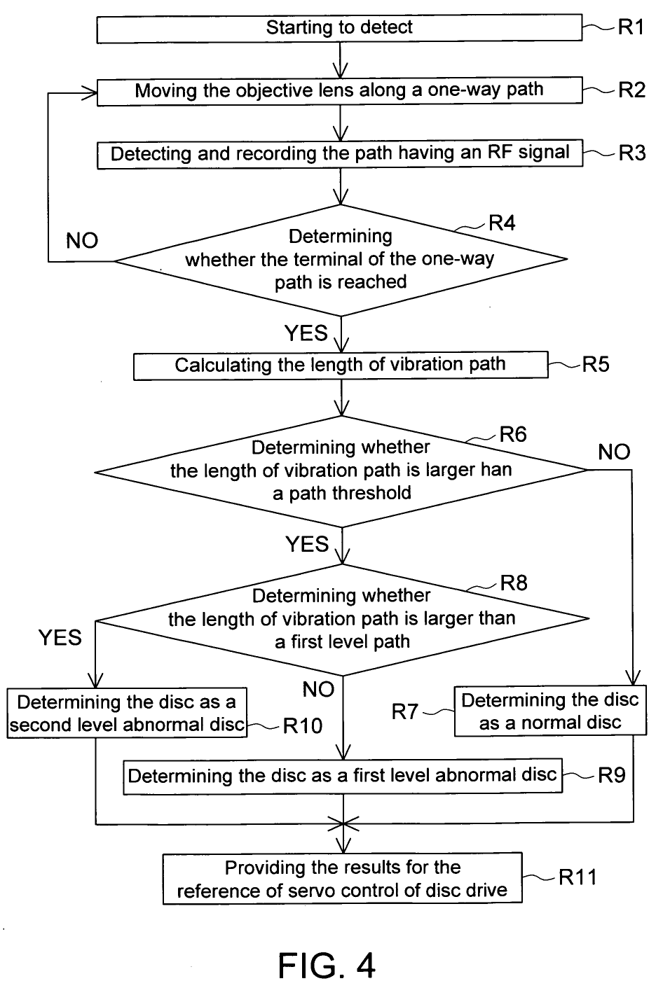

Referring to FIG. 4, a flowchart of a method of detecting an abnormal disc according to a second embodiment of the invention is shown. The present embodiment of the invention provides more accurate disc vibration for the reference of servo control of disc drive. According to the present embodiment of the invention, the abnormal disc determined in the previous embodiment is further graded according to the length of vibration path. The disc drive thus correctly steps down the rotation rate of the disc according to the level of vibration and immediately reduces disc vibration to an acceptable level. Thus, the focus can be fixed quickly and the disc drive has better efficiency. In theory, the vibration path can be graded to more than one level according to the accuracy and the need in the servo control of disc drive. In the present embodiment of the invention, the vibration is graded into two levels.

The present embodiment of the invention begins the detection at step R1 and determines whether a disc is a normal disc or an abnormal disc at the step R7, and step R1˜step R7 in the present embodiment of the invention which are the same as step P1˜step P7 of the method of detecting the abnormal disc in the first embodiment of the invention are not repeated here. After a disc is determined as an abnormal disc in step R7, the method of the present embodiment of the invention proceeds to step R8, whether the length of vibration path ΔT is larger than a first level path threshold is determined. If the length of vibration path ΔT is not larger than the first level path threshold, the method proceeds to step R9 and the abnormal disc is determined as an abnormal disc with first level vibration, and if the length of vibration path ΔT is larger than the first level path threshold, the method proceeds to step R10 and the abnormal disc is determined as an abnormal disc with second level vibration. Lastly, the method proceeds to the step R1, the results of the determination made in step R7, step R9 and step P10 are provided for the reference of servo control of disc drive.

According to the method of detecting the abnormal disc of the invention, the objective lens is moved along a one-way pat for enabling the light beam to pass through the data layer, the vibration path of the distribution of the RF signal is obtained and further graded according to the length of vibration path, such that vibration is accurately graded and used as a reference index in servo control of disc drive to facilitate the fixing of focus.

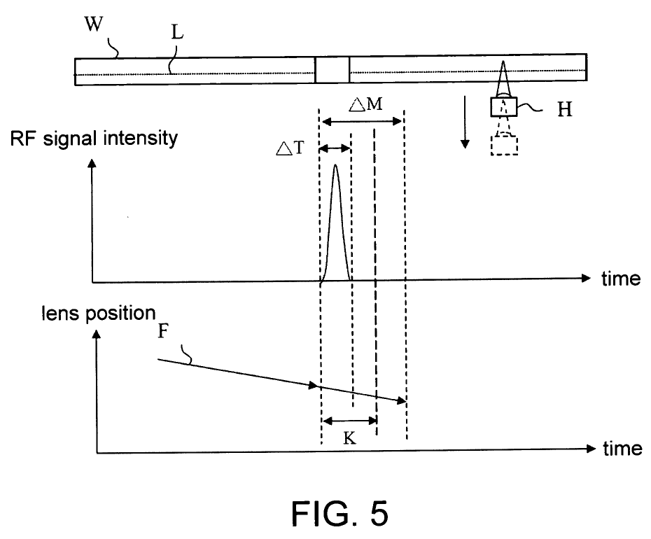

Referring to FIG. 5, a process of moving the light beam of the objective lens H to pass through the data layer L of the disc W and generate a signal according to a method of detecting an abnormal disc of a third embodiment of the invention is shown. In the present embodiment of the invention, the disc drive rotates the disc W and moves the objective lens H downwardly for allowing the light beam to pass through the data layer L of the disc W and detect whether a disc is abnormal. In the predetermined radius of the disc W, when the disc drive moves the objective lens H downwardly at a predetermined speed (referring to the line F in the diagram), the focal point of the light beam approaches the disc W. Before the focal point of the light beam approaches the data layer L, the intensity of the RF signal is almost zero. Once the focal point of the light beam approaches the data layer L, the reflected light increases and generates an effective RF signal which marks the starting point of the vibration path.

If the disc W is determined as a normal disc, the vertical vibration is within an acceptable range and the length of vibration path ΔT on which the RF signal is detected will be smaller than a path threshold K. If the RF signal is still detected after moving the objective lens H for a path ΔM whose length is larger than the path threshold K from the starting point where an effective RF signal is generated, it is evident that the length of vibration path ΔT of the disc W is larger than the path threshold K and the disc W can be immediately determined as an abnormal disc without having to move the objective lens H for a one-way path. Thus, the detection can be done in a shorter time and the efficiency of the disc drive is improved. Similarly, the process of moving the objective lens H for a path ΔM whose length is larger than a first level or a second level path threshold from the starting point where an effective RF signal is generated so as to grade the disc vibration can also be done in a shorter time.

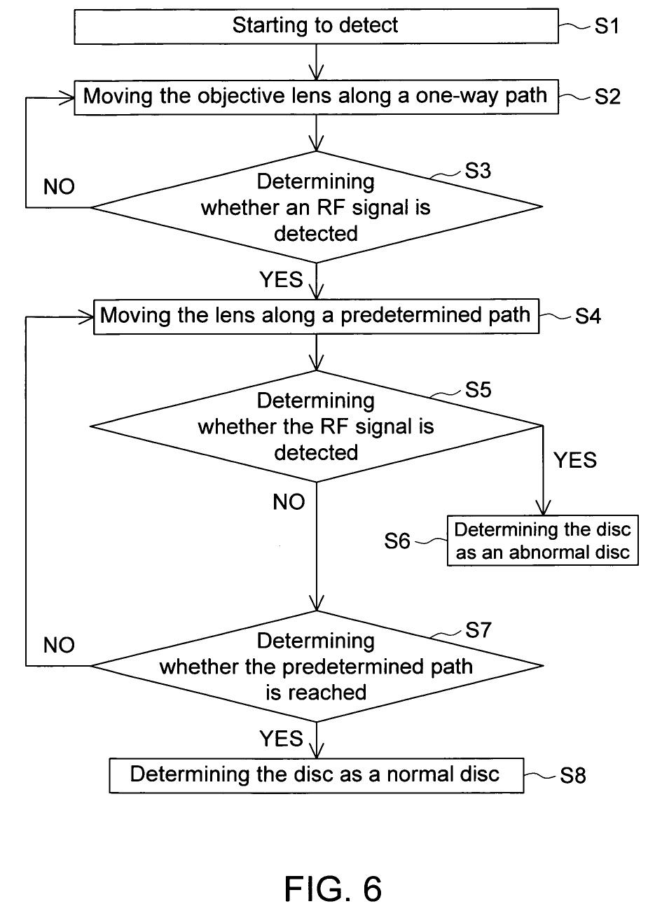

As indicated in FIG. 6, a flowchart of a method of detecting an abnormal disc according to a third embodiment of the invention is shown. In the method of detecting the abnormal disc of the present embodiment of the invention, a path ΔM whose length is larger than the path threshold K is used in the elaboration of detailed procedures. In the present embodiment of the invention, the method of detecting the abnormal disc begins at step S1, the disc drive starts to detect whether a disc is an abnormal disc. Next, the method proceeds to step S2, in the predetermined disc radius, the objective lens H is moved for enabling the reflected light to pass through the data layer L. Then, the method proceeds to step S3, an RF signal is detected on the path of the data layer L. If no RF signal is detected, the method returns to step S2 and continues to move the objective lens H. If the RF signal is detected, the method proceeds to step S4, the objective lens H continues to move for a predetermined path ΔM from the position of the RF signal. After that, the method proceeds to step S5, continues to detect the RF signal during the path ΔM. If the RF signal is detected, the method proceeds to step S6, the disc is determined as an abnormal disc. If no RF signal is detected, the method proceeds to step S7, whether the predetermined path ΔM is reached is checked: if the predetermined path ΔM is not reached, the method returns to step S4 and continues to move the objective lens H to complete the entire predetermined path ΔM, and if the predetermined path ΔM is reached, the disc is determined as a normal disc.

According to the method of detecting the abnormal disc of the third embodiment of the invention, when the reflected light of the lens passes through the data layer, the lens continues to move for a predetermined path after the RF signal is obtained. Whether the predetermined path has the RF signal is determined according to whether the length of predetermined path is larger than a path threshold K, a first level path threshold or a second level path threshold without having to complete the entire one-way path. As the abnormal disc or the vibration of the abnormal disc can be quickly detected, the detection efficiency is improved.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of detecting an abnormal disc, wherein the method comprises the following steps of:
(1) moving an objective lens along a one-way path for enabling a light beam of the objective lens to pass through a data layer of a disc;
(2) recording a path having an RF signal;
(3) calculating a length of vibration path on which the RF signal is detected; and
(4) determining whether the length of vibration path is larger than a path threshold, wherein if the length of vibration path is not larger than a path threshold, the disc is determined as a normal disc, and wherein if the length of vibration path is larger than the path threshold, the disc is determined as the abnormal disc.

2. The method of detecting the abnormal disc according to claim 1, wherein before a focus is fixed, the disc is rotated at a high rotation rate for detection.

3. The method of detecting the abnormal disc according to claim 1, wherein in the step (1), the objective lens is moved along the one-way path in a predetermined disc radius.

4. The method of detecting the abnormal disc according to claim 1, wherein in the step (1), the objective lens is moved at a predetermined speed.

5. The method of detecting the abnormal disc according to claim 1, wherein after detecting the path having the RF signal, the step (2) further comprises:
(2-1) checking whether a terminal of the one-way path is reached; wherein if the terminal of the one-way path is not reached, the method returns to the step (1) and continues moving the objective lens, and wherein if the terminal of the one-way path is reached, the method proceeds to the step (3).

6. The method of detecting the abnormal disc according to claim 1, wherein the RF signal detected and recorded in the step (2) is a data signal of light integral.

7. The method of detecting the abnormal disc according to claim 1, wherein the path threshold in the step (4) is determined according to a vibration range acceptable to the normal disc.

8. The method of detecting the abnormal disc according to claim 1, wherein if the disc is determined as the abnormal disc in the step (4), the method further comprises:
(4-1) checking whether the length of vibration path is larger than a first level path threshold, wherein if the length of vibration path is not larger than the first level path threshold, the disc is determined as a first level abnormal disc, and wherein if the length of vibration path is larger than the first level path threshold, the disc is determined as a second level abnormal disc.

9. The method of detecting the abnormal disc according to claim 8, wherein the first level path threshold is determined according to a vibration range larger than the vibration range acceptable to the normal disc.

10. The method of detecting the abnormal disc according to claim 1, wherein after a determination is made in the step (4), the method further comprises:
(5) providing a result of the determination for the reference of servo control of the disc drive.

11. A method of detecting an abnormal disc, wherein the method comprises:
(1) moving an objective lens along a one-way path for enabling a light beam of the objective lens to pass through a data layer of a disc;
(2) determining whether an RF signal is detected, wherein if no RF signal is detected, the method returns to the step (1), and wherein if the RF signal is detected, the method proceeds to the step (3);
(3) continuing moving the objective lens along a predetermined path;
(4) continuing detecting the RF signal, wherein if the RF signal is detected, the disc is determined as the abnormal disc, and wherein if no RF signal is detected, the method proceeds to the step (5); and
(5) checking whether the predetermined path is reached, wherein if the predetermined path is not reached, the method returns to the step (3), and wherein if the predetermined path is reached, the disc is determined as a normal disc.

12. The method of detecting the abnormal disc according to claim 11, wherein before a focus is fixed, the disc is rotated at a high rotation rate for detection.

13. The method of detecting the abnormal disc according to claim 11, wherein in the step (1), the objective lens is moved along the one-way path in a predetermined disc radius.

14. The method of detecting the abnormal disc according to claim 11, wherein in the step (3), a position of the RF signal detected in the step (2) is used as a starting point, and the objective lens continues to move along the predetermined path.

15. The method of detecting the abnormal disc according to claim 14, wherein a length of the predetermined path is larger than a path vibration threshold acceptable to the normal disc.

16. The method of detecting the abnormal disc according to claim 14, wherein the predetermined path is a path whose length is larger than a first level or a second level path threshold.
